(19) United States
(12) Patent Application Publication
(10) Pub. No.: US 2013/0066292 A1
(43) Pub. Date: Mar. 14, 2013

(54) SOFT MEDICAL CONTAINER AND NUTRIENT SUPPLY SYSTEM USING SAME

(71) Applicant: Takayuki Ueda, Hiroshima (JP)

(72) Inventor: Takayuki Ueda, Hiroshima (JP)

(73) Assignee: JMS CO., LTD., Hiroshima-shi, Hiroshima (JP)

(21) Appl. No.: 13/697,983

(22) PCT Filed: Mar. 30, 2011
(86) PCT No.: PCT/JP2011/058074

§ 371 Date: Nov. 14, 2012

(30) Foreign Application Priority Data
May 17, 2010 (JP) 2010-113460

(51) Int. Cl. A61J 1/10

(52) U.S. Cl. 604/404

(57) ABSTRACT

A soft medical container 1 of the present invention includes: a flexible bag member 2 formed by bonding at least two soft plastic sheets 2a and 2b together, wherein the flexible bag member 2 includes a reclosable mouth 4 and a container portion 21 for holding a liquid material, and at least one of the principal surfaces of the flexible bag member 2 is marked with a scale 2c for indicating the amount of the liquid material; an outlet port 3 fixed to the flexible bag member 2; and a pair of opening/closing operation portions 5a and 5b, wherein the opening/closing operation portions are fixed to the principal surfaces of the flexible bag member, respectively, and each form, together with the soft plastic sheet to which each opening/closing operation portion is fixed, a through path 7a, 7b into which a finger can be inserted from the left side or the right side of the flexible bag member 2.

### TECHNICAL FIELD

The present invention relates to a soft medical container and a nutrient supply system using the soft medical container.

### BACKGROUND ART

As examples of methods for administering a nutrient or a drug to a patient parenterally, transintestine nutrition therapy and intravenous nutrition therapy are known. In transintestine nutrition therapy, a liquid material such as a nutrient, a liquid diet, or a drug is administered to a patient through a tube running from the patient's nasal cavity to the stomach or the duodenum. Further, in intravenous nutrition therapy, a liquid material containing a nutrient component such as glucose and/or a drug component (generally referred to as an “infusion solution”) is administered to a patient through an infusion line inserted into the patient's vain.

When conducting transintestine nutrition therapy or intravenous nutrition therapy on a patient, a liquid material to be administered to the patient needs to be poured into an empty soft medical container in advance.

FIG. 26 is a plan view showing a schematic configuration of an example of a conventional soft medical container, FIG. 27 is a diagram showing a state where the mouth 700 of the soft medical container shown in FIG. 26 is held with one hand to open the mouth in an O shape, and FIG. 28 is a side view showing a state where a liquid material is poured into the soft medical container shown in FIG. 26.

The soft medical container 100 includes a container portion 300 for holding a liquid material and an outlet 500 having a through hole for taking out a liquid material held in the container portion 300. The container portion 300 is a bag-like member formed by overlaying flexible sheets on one another and heat bonding (heat sealing) the sheets together at their periphery. The outlet 500 is made of a resin material that is relatively harder than the sheets forming the container portion 300.

Into the empty soft medical container 100, a liquid material is poured as follows. First, the upper part of the mouth 700 is cut along a tear-off line 800 with a notch 400 being a starting point, and then a zip 600 is unfastened. Next, as shown in FIG. 27, the mouth 700 is held with one hand to open the mouth 700. At this time, the palm faces one of the two sheets. Subsequently, as shown in FIG. 28, a container 200 filled with a liquid material such as a drug or a nutrient is held with the other hand (not shown) to pour the liquid material into the container portion 300 through the opening of the mouth 700. At this time, if the liquid material is poured by placing the spout of the liquid material-filled container 200 at or close to a portion of the opening where the two sheets are the most distant from each other as shown in FIG. 28, the pouring can be carried out in a stable manner.

### PRIOR ART DOCUMENT

### Patent Document

Patent document 1: JP 2007-314245 A

### DISCLOSURE OF INVENTION

### Problem to Be Solved By the Invention

However, during the pouring of the liquid material into the conventional soft medical container 100, it is necessary to hold the mouth 700 with one hand to open the mouth 700 and to keep hold of the soft medical container 100 from the beginning to the end. With an increase in the amount of the liquid material poured into the soft medical container 100, the weight of the soft medical container 100 increases gradually. On the other hand, since the soft medical container 100 including the mouth 700 is made of a flexible material, the soft medical container 100 can deform easily if a strong holding force is exerted on the mouth 700. For these reasons, there are chances of dropping the soft medical container 100 and spilling the liquid material due to an inability to keep the mouth 700 in an opened state. Therefore, the pouring of a liquid material into the soft medical container 100 is significantly burdensome, physically and psychologically, for an operator.

Further, the main surface of the sheet(s) of the container portion may be marked with a scale for checking the amount of liquid material. However, it is difficult to read the scale when the soft medical container 100 is held in the manner as shown in FIGS. 27 and 28. For example, when the pouring of the liquid material into the container portion 300 is performed with the sheet marked with the scale facing the operator, in order to read the scale and to pour the liquid material into the container portion 300 at the same time, it is necessary to pour the liquid material into the container portion 300 from the right side, given that the left side is where the mouth 700 held with one hand is in contact with the thumb and the right side is where the mouth 700 is in contact with other fingers. In this case, however, it is difficult to perform the pouring of the liquid material.

The present invention provides a soft medical container with the following advantages: a liquid material can be poured into the soft medical container in an empty state with ease, and a scale is easy to read during the pouring of the liquid material.

### Means for Solving Problem

The soft medical container of the present invention includes: a flexible bag member formed by bonding at least two soft plastic sheets together, wherein the flexible bag member includes a reclosable mouth and a container portion for holding a liquid material, and at least one of the principal surfaces of the flexible bag member is marked with a scale for indicating the amount of the liquid material; an outlet port fixed to the flexible bag member; and a pair of opening/closing operation portions, wherein the opening/closing operation portions are fixed to the principal surfaces of the flexible bag member, respectively, and each form, together with the soft plastic sheet to which each opening/closing operation portion is fixed, a through path into which a finger can be inserted from the left side or the right side of the flexible bag member.

The nutrition supply system of the present invention includes the soft medical container of the present invention.

### Effects of the Invention

The soft medical container of the present invention includes the opening/closing operation portions that are fixed to the principal surfaces of the flexible bag member, respectively, and each form, together with the soft plastic sheet to which each opening/closing operation portion is fixed, a through path into which a finger can be inserted from the left side or the right side of the mouth. Thus, a liquid material readily can be poured into the soft medical container in an empty state, and also the scale is easy to read during the pouring of the liquid material.

### BRIEF DESCRIPTION OF THE DRAWINGS

FIG. 1 is a perspective view showing a schematic configuration of an exemplary soft medical container according to Embodiment 1 of the present invention.

FIG. 2A is a plan view of the soft medical container shown in FIG. 1.

FIG. 2B is a side view of the soft medical container shown in FIG. 1.

FIG. 3 is a side view showing a state where the soft medical container shown in FIG. 1 is held with one hand to open the mouth of the container.

FIG. 4 is a different side view showing the state where the soft medical container shown in FIG. 1 is held with one hand to open the mouth of the container.

FIG. 5 is a plan view showing a state where a liquid material is poured into the soft medical container shown in FIG. 1.

FIG. 6 is an illustration of a transintestine nutrition supply system including the soft medical container shown in FIG. 1.

FIG. 7 is a perspective view showing a schematic configuration of an exemplary soft medical container according to Embodiment 2 of the present invention.

FIG. 8 is a different perspective view of the soft medical container shown in FIG. 7.

FIG. 9 is a perspective view showing a schematic configuration of an exemplary soft medical container according to Embodiment 3 of the present invention.

FIG. 10 is a perspective view showing a schematic configuration of an exemplary soft medical container according to Embodiment 4 of the present invention.

FIG. 11A is a plan view of the soft medical container shown in FIG. 10.

FIG. 11B is a side view of the soft medical container shown in FIG. 10.

FIG. 11C is a rear view of the soft medical container shown in FIG. 10.

FIG. 12 is a side view showing a state where the soft medical container shown in FIG. 10 is held with one hand to open the mouth of the container.

FIG. 13 is a perspective view showing a schematic configuration of an exemplary soft medical container according to Embodiment 5 of the present invention.

FIG. 14A is a plan view of the soft medical container shown in FIG. 13.

FIG. 14B is a side view of the soft medical container shown in FIG. 13.

FIG. 15 is a perspective view showing a state where the soft medical container shown in FIG. 13 is held with one hand to open the mouth of the container.

FIG. 16A is a perspective view showing a schematic configuration of an exemplary soft medical container according to Embodiment 6 of the present invention.

FIG. 16B is a schematic plan view for explaining the mouth of the soft medical container shown in FIG. 16A in an opened state.

FIG. 17A is a plan view of the soft medical container shown in FIG. 16A.

FIG. 17B is a side view of the soft medical container shown in FIG. 16A.

FIG. 18 is a plan view showing a schematic configuration of a different exemplary soft medical container according to Embodiment 6 of the present invention.

FIG. 19 is a perspective view showing a schematic configuration of an exemplary soft medical container according to Embodiment 7 of the present invention.

FIG. 20A is a plan view of the soft medical container shown in FIG. 19.

FIG. 20B is a side view of the soft medical container shown in FIG. 19.

FIG. 21 is a diagram showing a state where the soft medical container shown in FIG. 19 is held with one hand to open the mouth of the container.

FIG. 22 is a perspective view showing a schematic configuration of an exemplary soft medical container according to Embodiment 8 of the present invention.

FIG. 23A is a plan view of the soft medical container shown in FIG. 22.

FIG. 23B is a side view of the soft medical container shown in FIG. 22.

FIG. 23C is a rear view of the soft medical container shown in FIG. 22.

FIG. 24 is a perspective view showing a schematic configuration of an exemplary soft medical container according to Embodiment 9 of the present invention.

FIG. 25A is a plan view of the soft medical container shown in FIG. 24.

FIG. 25B is a side view of the soft medical container shown in FIG. 24.

FIG. 26 is a plan view showing a schematic configuration of an example of a conventional soft medical container.

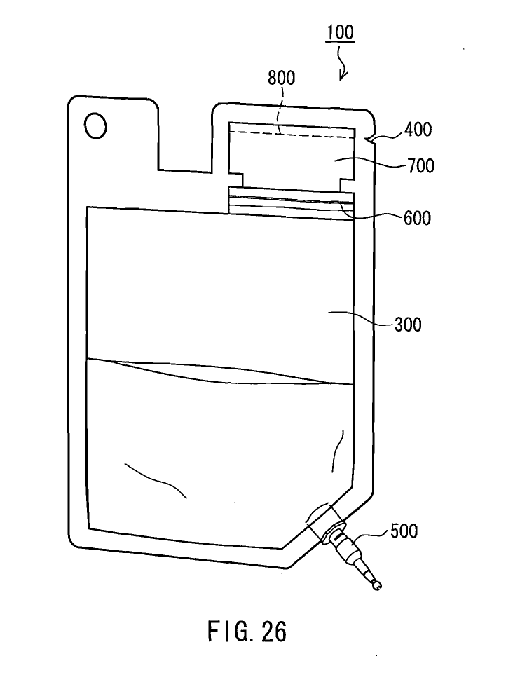

FIG. 27 is a diagram showing a state where the mouth of the soft medical container shown in FIG. 26 is held with one hand to open the mouth.

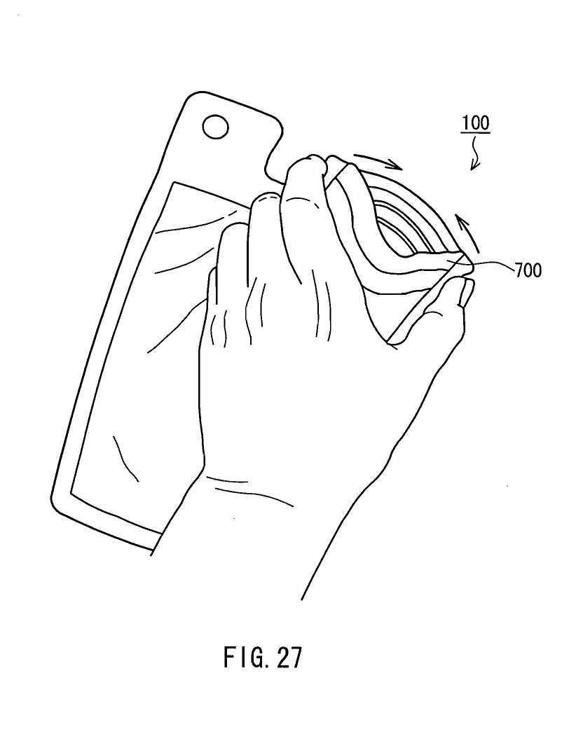

FIG. 28 is a side view showing a state where a liquid material is poured into the soft medical container shown in FIG. 26.

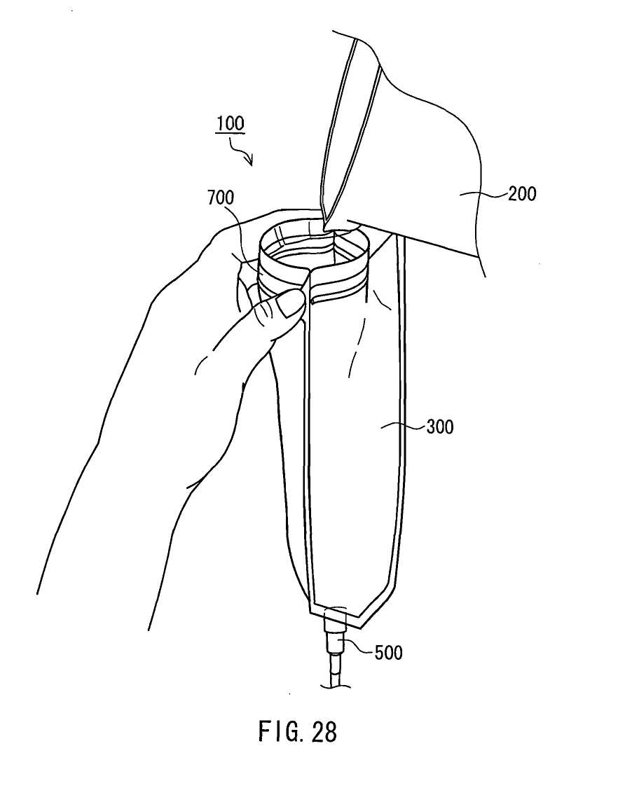

### DESCRIPTION OF THE INVENTION

Hereinafter, examples of the soft medical container of the present invention will be described with reference to the drawings.

### Embodiment 1

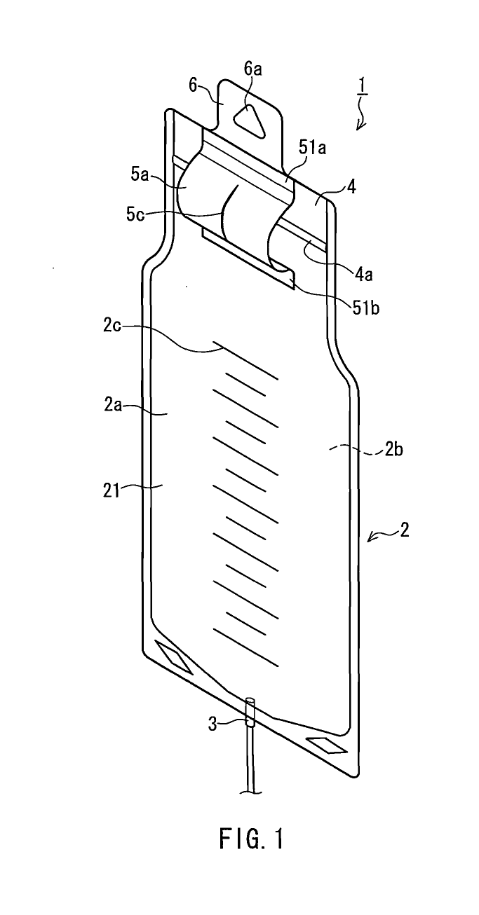

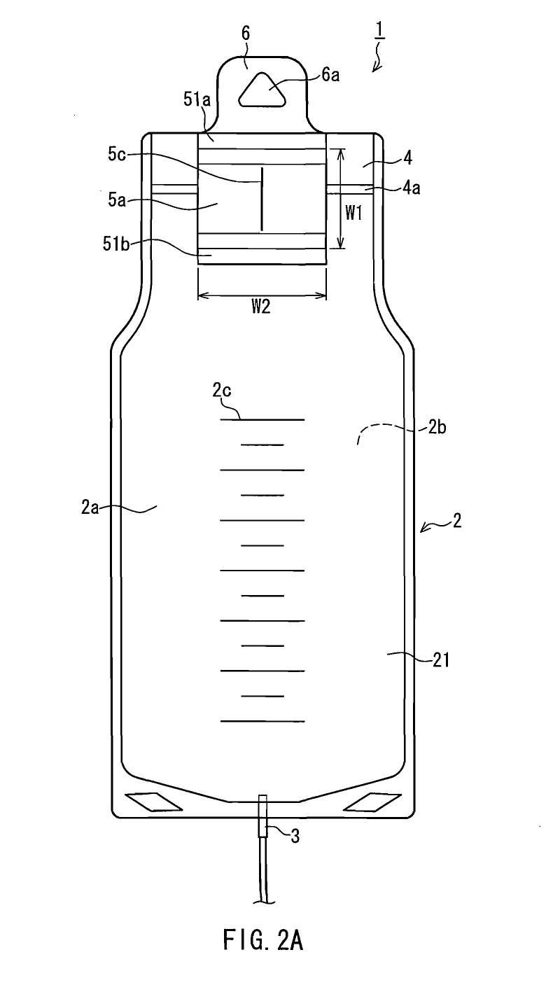

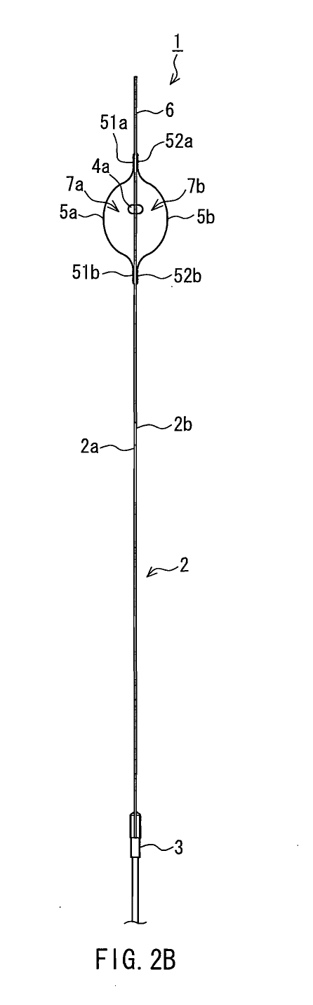

FIG. 1 is a perspective view of an exemplary soft medical container according to Embodiment 1 of the present invention, FIG. 2A is a plan view of the soft medical container shown in FIG. 1, and FIG. 2B is a side view of the soft medical container shown in FIG. 1. Herein, the “upper side” (the upper side of the sheet of FIG. 1) and the “lower side” (the lower side of the sheet of FIG. 1) of the soft medical container 1 are defined in line with how the soft medical container 1 is used in reality. Further, a lateral direction in a plan view or a rear view of the soft medical container 1 will be referred to as a “width direction”.

The soft medical container 1 shown in FIGS. 1 to 2B includes: a flexible bag member 2 having a flat bag-like shape and including a reclosable mouth 4 and a container portion 21 for holding a liquid material; and an outlet port 3 fixed to the flexible bag member 2. The flexible bag member 2 includes a hanger 6 through which the soft medical container 1 is hanged on a stand or the like. The hanger 6 is situated on the upper side with respect to the mouth 4 and has a hanging hole 6a.

The flexible bag member 2 is formed by, for example, overlaying a soft plastic sheet 2a on a soft plastic sheet 2b and heat bonding (heat sealing) the two soft plastic sheets together at their periphery. The outer principal surface of the soft plastic sheet 2a is marked with a scale 2c for checking the amount of liquid material to be poured into the flexible bag member 2. Hereinafter, the principal surface of the soft plastic sheet 2a marked with the scale 2c, namely, the surface that will oppose an operator when he charges a liquid material into the flexible bag member 2, will be referred to as the “front side”, and positional relationships between the left side and the right side will be explained with reference to the “front side”. When a liquid material is charged into the flexible bag member 2, the mouth 4 is situated on the upper side with respect to the container portion 21.

The outlet port 3 is a tube-like component and has, for example, a through hole at the center. The outlet port 3 is sandwiched between the two soft plastic sheets 2a and 2b and is fixed to the flexible bag member 2 so as to allow communication between the inside and the outside of the flexible bag member 2. The outlet port 3 can be fixed to the flexible bag member 2 by, for example, placing the outlet port 3 between the two soft plastic sheets 2a and 2b, and heat bonding the soft plastic sheets 2a and 2b together at their periphery

The mouth 4 includes, for example, a zip 4a (an engagement portion that makes the mouth 4 reclosable; also known as a “zip seal”) for making the mouth 4 reclosable. The zip 4a lies across the mouth 4 in the width direction. The zip 4a can be formed by a conventionally known method. For example, the zip 4a can be formed by heat-bonding zip tapes (in a pair) forming the zip 4a to the opposing surfaces (inner surfaces) of the soft plastic sheets 2a and 2b, respectively.

The shape of the flexible bag member 2 is not particularly limited, and may be rectangular, elliptical, or the like, for example. However, it is preferable that the lower part of the container portion 21 is slightly tapered toward the outlet port 3 so as to make a liquid material or the like in the soft medical container 1 flow readily toward the outlet port 3.

An opening/closing operation portion 5a is fixed onto the outer principle surface of the soft plastic sheet 2a, and an opening/closing operation portion 5b is fixed onto the outer principle surface of the soft plastic sheet 2b. Each of the opening/closing operation portions 5a and 5b is composed of a sheet-like material. The opening/closing operation portion 5a is fixed onto the outer principle surface of the soft plastic sheet 2a and the opening/closing operation portion 5b is fixed onto the outer principle surface of the soft plastic sheet 2b by a fixing method, such as heat bonding (heat sealing), so that through paths 7a and 7b (see FIG. 2B) into which a finger can be inserted from the left side or the right side of the mouth 4 are formed between the opening/closing operation portion 5a and the soft plastic sheets 2a and between the opening/closing operation portion 5b and the soft plastic sheets 2b, respectively. That is, an upper end 51a and a lower end 51b of the sheet-like material forming the opening/closing operation portion 5a are fixed to the soft plastic sheet 2a such that the center part of the sheet-like material sags with respect to the soft plastic sheet 2a, and an upper end 52a and a lower end 52b of the sheet-like material forming the opening/closing operation portion 5b are fixed to the soft plastic sheet 2b such that the center part of the sheet-like material sags with respect to the soft plastic sheet 2b. The upper ends 51a and 52a are fixed, for example, on the upper side with respect to the zip 4a and the lower ends 51b and 52b are fixed, for example, on the lower side with respect to the zip 4a. The spacing between the upper end 51a and the lower end 51b and the spacing between the upper end 52a and the lower end 52b in the vertical direction are set as appropriate in consideration of ease of opening the mouth 4. The sheet-like materials are soft plastic sheets, for example, heat bondable to the soft plastic sheets 2a and 2b.

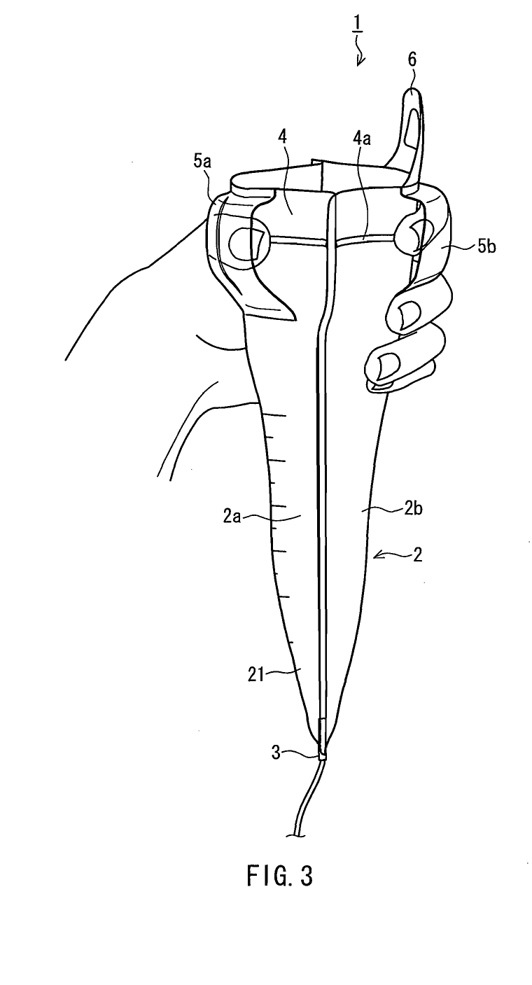

As described above, if the opening/closing operation portions 5a and 5b are fixed to the mouth 4, the mouth 4 can be kept in an opened state with one hand as shown in FIG. 3 by inserting the thumb in one of the through paths (through path 7a) and a different finger (e.g., a forefinger) in the other through path (through path 7b) and pressing the thumb against the inner surface of the opening/closing operation portion 5a and pressing the forefinger against the inner surface of the opening/closing operation portion 5b to move the fingers away from each other. Further, since the thumb and the forefinger are inserted in the through paths 7a and 7b, respectively (see FIG. 2B), the mouth 4 readily and stably can be kept in an opened state. Furthermore, it is possible to reduce the chances of dropping the soft medical container 1 and spilling a liquid material due to an inability to keep the mouth 4 in an opened state. Therefore, physical and psychological burdens borne by an operator during the pouring of a liquid material into the soft medical container 1 can be reduced.

The locations for fixing the opening/closing operation portions 5a and 5b are not particularly limited as long as the mouth 4 can be kept in an opened state. However, when the mouth 4 is provided with, for example, the zip 4a, it is preferable that the zip 4a can be unfastened by operating the opening/closing operation portions 5a and 5b with one hand. Specifically, it is preferable that the opening/closing portions 5a and 5b are fixed to the soft plastic sheets 2a and 2b, respectively, such that the through paths 7a and 7b lie adjacent to the zip 4a and along the longitudinal direction of the zip 4a. That is, it is preferable that the opening/closing operation portion 5a forms, together with the soft plastic sheet 2a, the through path 7a and the opening/closing operation portion 5b forms, together with the soft plastic sheet 2b, the through path 7b into which a finger can be inserted from the left side or the right side of the mouth 4. More specifically, it is preferable that the upper end 51a of the opening/closing operation portion 5a and the upper end 52a of the opening/closing operation portion 5b are fixed to the soft plastic sheets 2a and 2b, respectively, on the upper side with respect to the engagement portion of the mouth 4 such as the zip 4a, and the lower end 51b of the opening/closing operation portion 5a and the lower end 52b of the opening/closing operation portion 5b are fixed to the soft plastic sheets 2a and 2b, respectively, on the lower side with respect to the engagement portion such as the zip 4a.

The width W1 of each of the opening/closing operation portions 5a and 5b in the vertical direction (the distance between the upper end 51a and the lower end 51b and the distance between the upper end 52a and the lower end 52b; see FIGS. 2A and 2B) is not particularly limited as long as a finger is readily insertable into the opening/closing operation portions 5a and 5b and the opening/closing operation portions 5a and 5b can be operated with one hand.

The width W2 of each of the opening/closing operation portions 5a and 5b in the lateral direction (see FIG. 2A) is not particularly limited as long as the opening/closing operation portions 5a and 5b can be operated with one hand but is preferably, for example, 20 mm to 60 mm. The width W2 is preferably large enough so that the area where the opening/closing operation portions 5a and 5b are bonded to the soft plastic sheets 2a and 2b, respectively, readily can be ensured and the mouth 4 can be kept in an opened state regardless of the size of a hand. On the other hand, the width W2 is preferably small enough so that a force can be exerted effectively on the soft plastic sheets 2a and 2b forming the mouth 4 to move them apart from each other to spread the mouth 4 wide open.

In terms of improving the ease of opening the mouth 4, it is preferable that at least one of the opening/closing operation portions 5a and 5b has a slit 5c whose longitudinal direction is in the up-down direction, and it is more preferable that both the opening/closing operation portions 5a and 5b have the slit 5c. If the opening/closing operation portions 5a and 5b have a slit, the following can be achieved; by opening the mouth 4 with fingers being inserted into the slits 5c, the mouth 4 readily can be spread wide open. Further, from the same reason, it is more preferable that the opening/closing operation portions 5a and 5b include the slit 5c at a position corresponding to a center part of the mouth 4 in the width direction, particularly to the center of the mouth 4 in the width direction.

In the example shown in FIG. 2A, the slit 5c is formed perpendicular to the width direction of the mouth 4 but it does not need to be formed in this way as long as the longitudinal direction of the slit is in the up-down direction. Thus, the slit may be inclined toward either the left side or the right side. The pair of opening/closing operation portions 5a and 5b may have the same shape or different shapes from each other. The term “opening the mouth 4” includes not only unfastening the zip 4a or the like to release the mouth 4 from a closed state but separating from each other the soft plastic sheets 2a and 2b forming the opening 4 that have been released from a closed state. After unfastening the zip 4a or the like to release the mouth 4 from a closed state, fingers may be inserted into the through paths 7a and 7b, respectively, to separate the soft plastic sheets 2a and 2b forming the mouth 4 from each other. Therefore, “opening the mouth 4” may mean only that fingers are inserted into the through paths 7a and 7b, respectively, to separate the soft plastic sheets 2a and 2b forming the mouth 4 from each other.

Further, when the mouth 4 is shaped left-right symmetric as in the example shown in FIG. 2A, it is more preferable that the opening/closing operation portions 5a and 5b have the slit 5c at the position corresponding to the center of the mouth 4 in the width direction and the longitudinal direction of the slit 5c is substantially perpendicular to the width direction of the mouth 4. This is because the operability does not change regardless of the dominant hand.

One or more slits 5c may be provided for one opening/closing operation portion and the number thereof is thus not particularly limited.

The way to fix the opening/closing operation portions 5a and 5b to the soft plastic sheets 2a and 2b, respectively, is not particularly limited, and an adhesive or heat bonding (heat sealing) may be used, for example. However, in terms of a favorable appearance and ease of use, heat bonding is preferable. When fixing the opening/closing operation portions 5a and 5b to the soft plastic sheets 2a and 2b, respectively, by heat bonding, the opening/closing operation portions 5a and 5b can be fixed to the soft plastic sheets 2a and 2b, respectively, in tandem with the formation of the flexible bag member 2.

The hanger 6 may be extended from the mouth 4. For example, one soft plastic sheet 2b may serve as a rear-side soft plastic sheet constituting the hanger 6, the opening 4 and the container portion 21. Further, a part of the front-side soft plastic sheet situated on the upper side with respect to the engagement portion, such as the zip, and on the left side and/or the right side with respect to the engagement portion may be heat-bonded to the rear-side soft plastic sheet to partially constitute the hanger 6. Further, a piece of sheet with a margin used to fix the piece to the mouth 4 may be used to form the hanger 6. The hanger 6 may have a layered structure. That is, one soft plastic sheet 2b may partially constitute the hanger 6, the mouth 4 and the container portion 21, and a different sheet may be laminated onto a part of the hanger 6 for reinforcement.

As shown in FIGS. 1 and 2A, when the hanging hole 6a is on the line extending from the central axis of the outlet port 3 and the central axis of the outlet port 3 corresponds to the line extending from the vertical center line that divides the inside of the lower part of the container portion 21 into two equal parts in the width direction, the amount of liquid material held in the container portion 21 can be checked relatively precisely through the scale marked on the front side of the container portion 21.

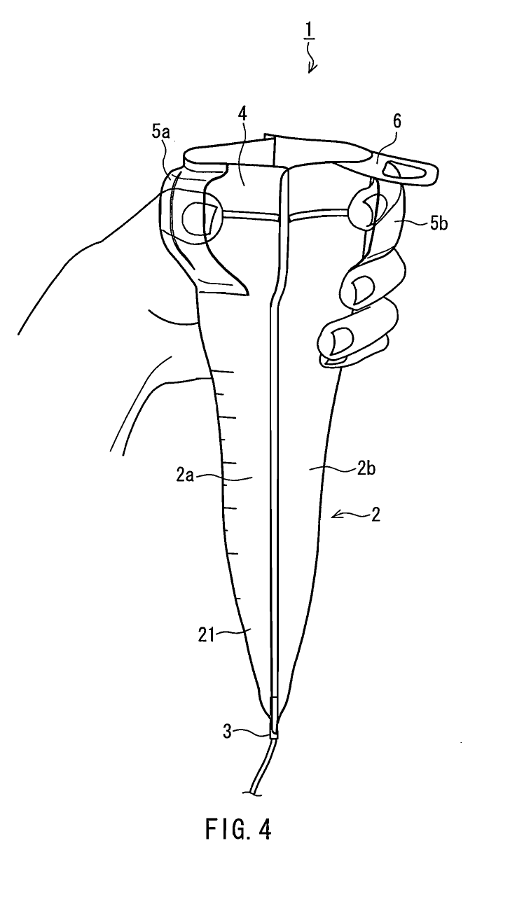

As shown in FIG. 4, it is preferable that a portion close to the boundary between the hanger 6 and the mouth 4 can be bent outwardly with ease and can be kept in that state. This is preferable because a liquid material can be poured into the container portion 21 more readily. In order for the hanger 6 to be readily bendable outwardly and to be able to keep a bent state, the hanger 6 may be configured such that it is harder than the soft plastic sheets forming the mouth 4.

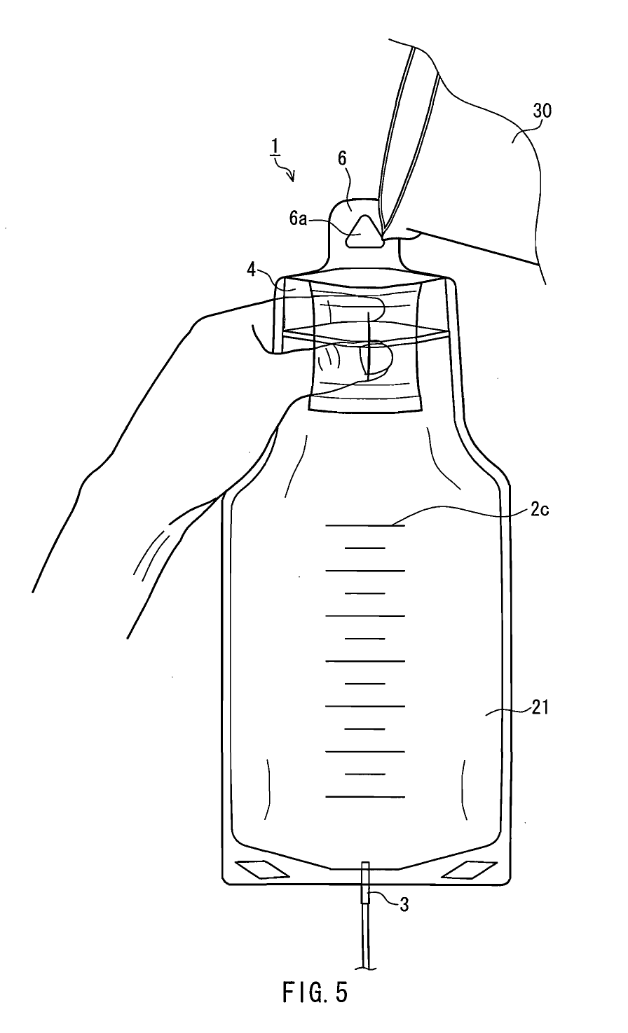

FIG. 5 shows a state where a liquid material is poured into the container portion 21 while the soft medical container 1 with the mouth 4 being opened is held with one hand. The front side of the soft medical container 1 opposes the operator, and the left hand holding the soft medical container 1 and the right hand (not shown) holding a container 30 filled with the liquid material oppose each other. Therefore, it is easy to read the scale 2c during the pouring of the liquid material and the pouring of the liquid material into the soft medical container 1 can be performed readily. Note that the operator's dominant hand is his right hand in the state shown in FIG. 5.

After the pouring of the liquid material, the engagement portion such as a zip is fastened to close the mouth 4. When the soft medical container 1 filled with the liquid material as above is hung on a stand or the like through the use of the hanging hole 6a of the hanger 6 situated on the upper side with respect to the mouth 4, the liquid material can be supplied smoothly to a patient or the like till the last drop because the outlet port 3 sits at the bottom.

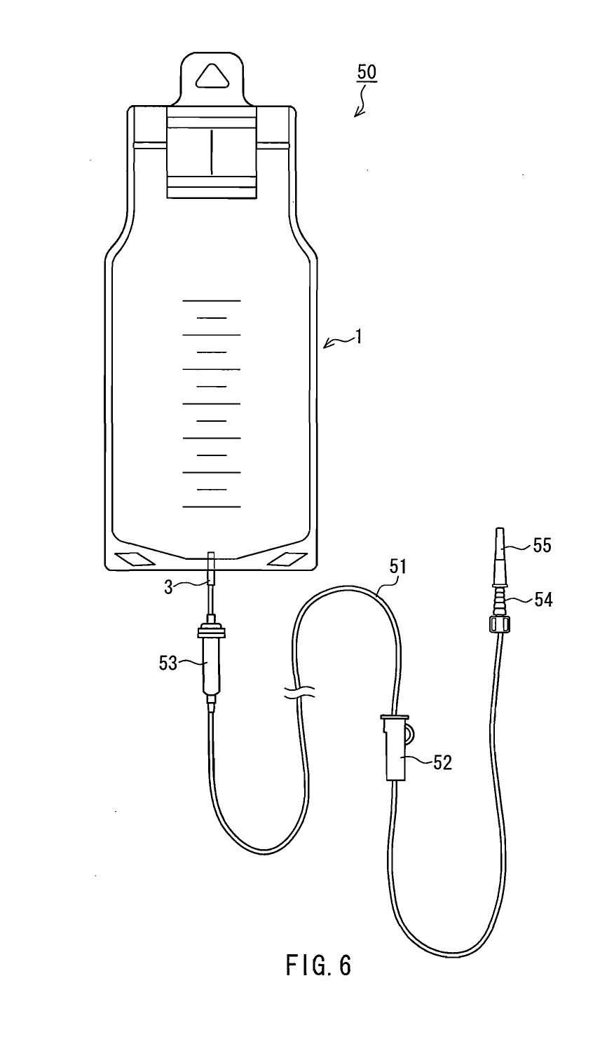

As shown in FIG. 6, one example of the soft medical container of the present invention is used as a component of a nutrient supply system such as a transintestine nutrient supply system 50, for example. The transintestine nutrient supply system 50 includes, for example, a flexible tube 51 connected to the outlet port 3, a flow rate adjuster 52 for adjusting the flow rate of liquid material flowing inside the flexible tube 51 by pressing the flexible tube 51, a drip tube 53, a connector 54 and a connector cover 55. The drip tube 53 makes the flow rate of the liquid material flowing inside the flexible tube 51 visible. The connector 54 is connected to, for example, a tube inserted in the patient's nasal cavity. However, the configuration of the transintestine nutrient supply system of the present invention is not limited to the one shown in FIG. 6, and the transintestine nutrient supply system further may include components used in conventionally-known transintestine nutrient supply systems. For example, when the outlet port 3 serves also as a connector, the liquid-sending line including the flexible tube 51, the flow rate adjuster 52, the drip tube 53, the connector 54 and the connector cover 55 may include a connector at the opposite end to the connector cover 55 and may be connectable to/disconnectable from the soft medical container 1 through the outlet port 3.

The material of the soft plastic sheets 2a and 2b forming the container portion 21 is not particularly limited, and conventionally-known soft plastic sheets used for soft medical containers can be used. Specifically, examples of the material of the soft plastic sheets 2a and 2b include a single layer sheet made of vinyl chloride resin, polyethylene, an ethylene-vinyl acetate copolymer, polyester, polybutadiene, polypropylene, polyamide, an ethylene-methacrylate copolymer, or the like, and a multi-layered sheet obtained by layering the single layer sheets. Examples of the specific layer configuration of the multi-layered sheet include nylon/polyethylene, nylon/polypropylene, polyethylene terephthalate/polyethylene, polyethylene terephthalate/polypropylene, polypropylene/polyethylene, and nylon/polypropylene/polyethylene. The soft plastic sheets have a thickness of for example, about 0.1 to 0.6 mm.

Examples of the material of the outlet port 3 include cyclic polyolefin, polycarbonate, polyethylene terephthalate, polypropylene and polyethylene naphthalate.

For example, the opening/closing operation portions 5a and 5b may be made of the same material as that of the soft plastic sheets 2a and 2b forming the container portion 21.

In the exemplary soft medical container of the present invention explained with reference to FIGS. 1 to 5, only the soft plastic sheet 2a is marked with the scale for indicating the amount of liquid material but the plastic sheet 2b also may be marked with a scale. In this case, an operator can pour a liquid material into the soft medical container 1 stably regardless of his dominant hand while reading the scale during the pouring of the liquid material. When both the soft plastic sheets 2a and 2b are marked with the scale 2c in the exemplary soft medical container of the present invention explained with reference to FIGS. 1 to 5, the principal surface of either soft plastic sheet can be referred to as the “front side”.

In the exemplary soft medical container of the present invention explained with reference to FIGS. 1 to 5, the engagement portion such as a zip (zip seal) is used as the means for making the mouth 4 reclosable. However, other conventionally-known opening/closing means may be used as long as they do not interfere with opening of the mouth through the opening/closing operation portions 5a and 5b, keeping of the mouth in an opened state, and the ease of pouring a liquid material into the container portion. Further, in the exemplary soft medical container of the present invention explained with reference to FIGS. 1 to 5, the two soft plastic sheets 2a and 2b are used to form the flexible bag member 2. However, as long as the flexible bag member 2 is formed by bonding at least two soft plastic sheets together, for example, a soft plastic sheet for reinforcing the mouth 4 further may be used in addition to the soft plastic sheets 2a and 2b to form the flexible bag member 6 to enhance the strength of the mouth 4, or a soft plastic sheet for forming the hanger 6 further may be used.

### Embodiment 2

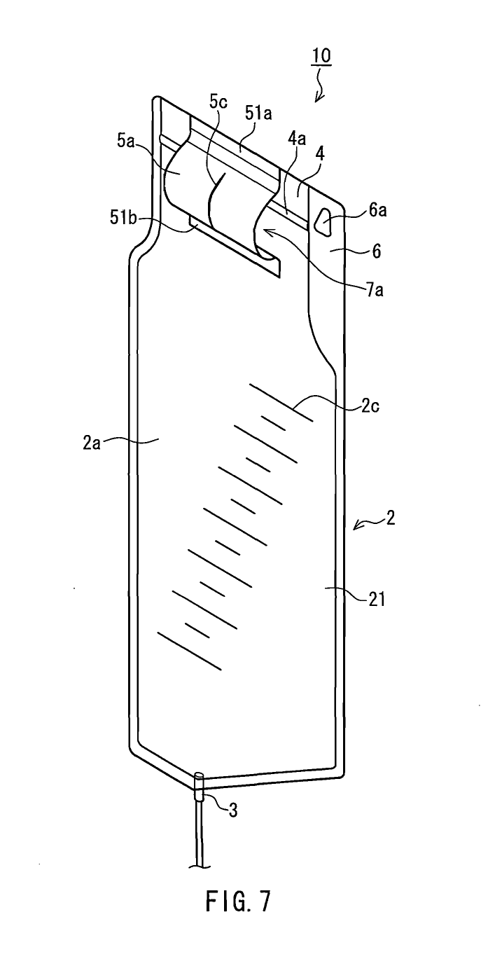

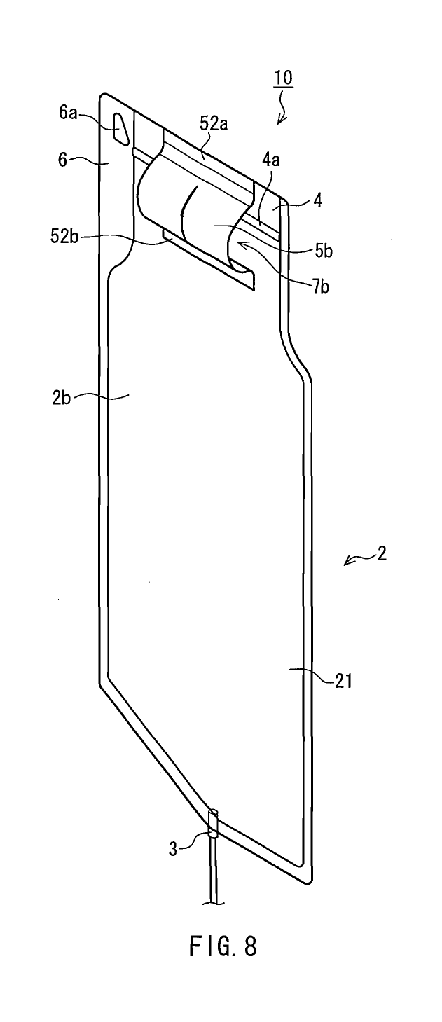

FIG. 7 is a perspective view of an exemplary soft medical container according to Embodiment 2 of the present invention, and FIG. 8 is a different perspective view of the soft medical container shown in FIG. 7.

The soft medical container 10 according to the present embodiment has the same configuration as that of the soft medical container according to Embodiment 1 except for the location of the hanger 6, the location of the outlet port 3, and the angle of the scale 2c. In FIGS. 7 and 8, the same components as those of the soft medical container according to Embodiment 1 are denoted by the same reference numerals.

As shown in FIG. 7, the soft medical container 10 according to the present embodiment includes the hanging hole 6a on the right side of the mouth 4, and no hanger on the upper side with respect to the mouth 4. Thus, in comparison with the soft medical container according to Embodiment 1 having the hanger 6 on the upper side with respect to the mouth 4, this soft medical container is preferable because it is favorably producible and a liquid material can be poured into the container portion 21 more readily.

### Embodiment 3

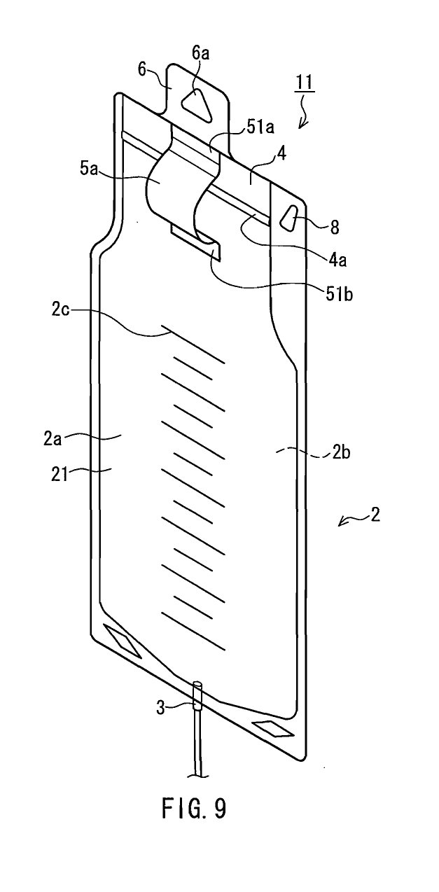

FIG. 9 is a perspective view of an exemplary soft medical container according to Embodiment 3 of the present invention.

The soft medical container 11 according to the present embodiment has the same configuration as that of the soft medical container according to Embodiment 1 except for having a line temporary-holding hole 8 into which a liquid-sending line such as a flexible tube (not shown) connected to the outlet port 3 can be inserted, the width W2 of each opening/closing operation portion (see FIG. 2A) being smaller than that in the soft medical container 1 shown in FIG. 2A, and the opening/closing operation portions including no slit 5c (see FIG. 2A). In FIG. 9, the same components as those of the soft medical container according to Embodiment 1 are denoted by the same reference numerals.

For example, by inserting a bent flexible tube into the line temporary-holding hole 8 of the soft medical container 11 when hanging the soft medical container 11 on a stand or charging a liquid material into the container portion 21 of the soft medical container 11, the components of the transintestine nutrient supply system on the downstream side (e.g., the connector 54 and the connector cover 55; see FIG. 6) can be prevented from contacting the floor.

### Embodiment 4

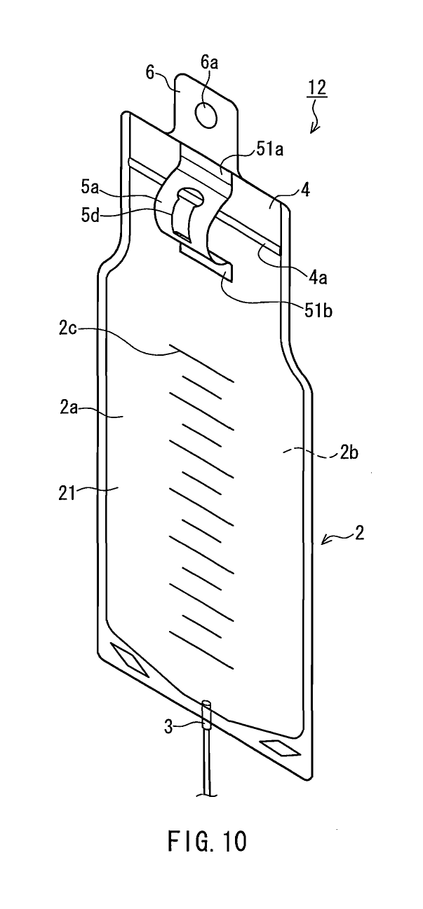

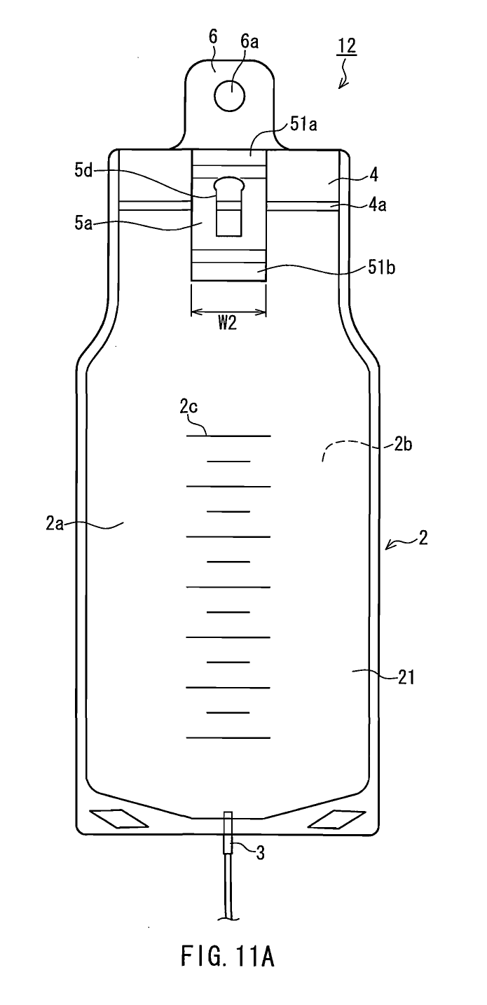

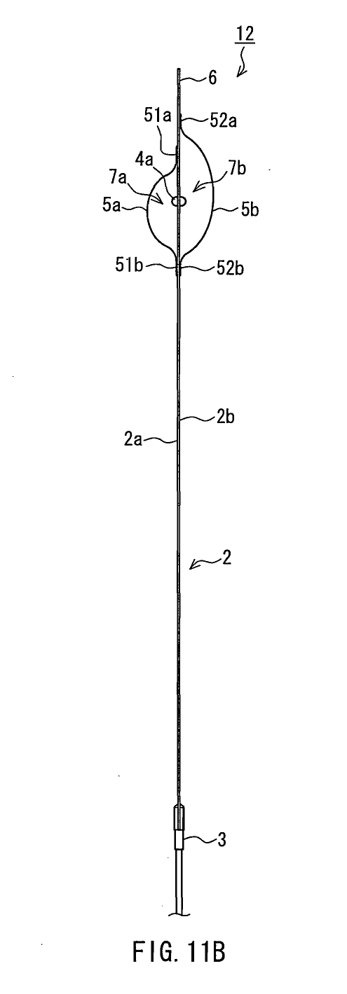

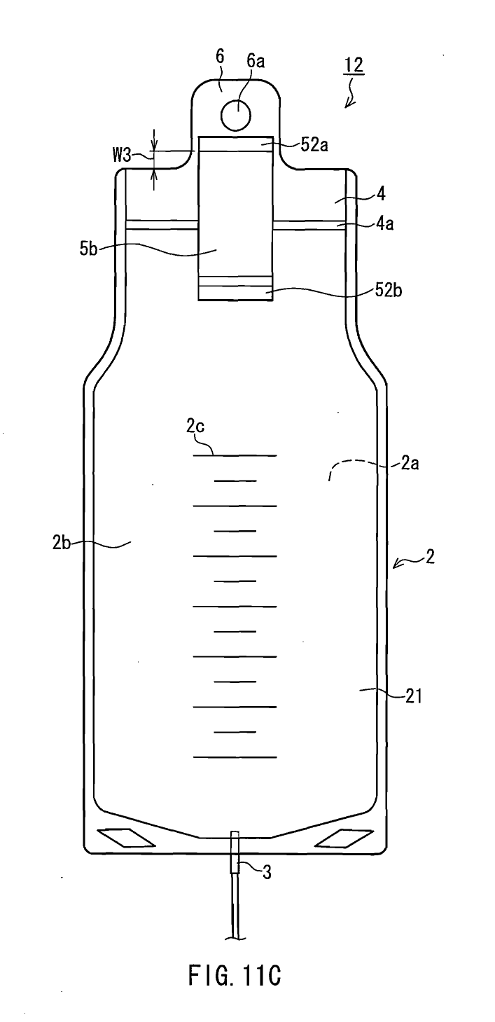

FIG. 10 is a perspective view of an exemplary soft medical container according to Embodiment 4 of the present invention, FIG. 11A is a plan view of the soft medical container shown in FIG. 10, FIG. 11B is a side view of the soft medical container shown in FIG. 10, and FIG. 11C is a rear view of the soft medical container shown in FIG. 10.

The soft medical container 12 according to the present embodiment has the same configuration as that of the soft medical container according to Embodiment 1 except for the location for fixing the upper end 52a of the opening/closing operation portion 5b, the shape of the hanging hole 6a., the width W2 of each of the opening/closing operation portions 5a and 5b in the lateral direction (see FIG. 2A) being smaller than that in the soft medical container 1 shown in FIG. 2A, the opening/closing operation portion 5a having, in place of the slit 5c (see FIG. 1), a hole 5d with a predetermined width in the lateral direction, and both the soft plastic sheets 2a and 2b being marked with the scale 2c. In FIGS. 10 to 12, the same components as those of the soft medical container according to Embodiment 1 are denoted by the same reference numerals.

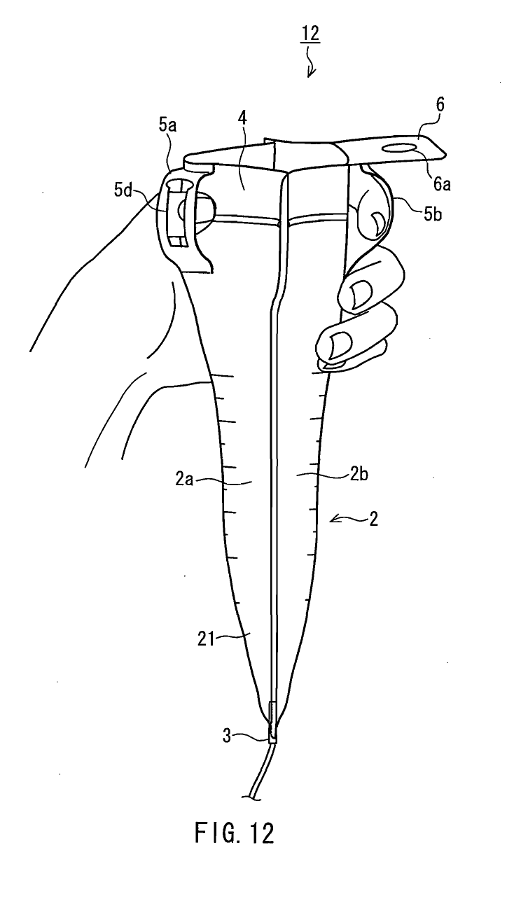

In the soft medical container 12 according to the present embodiment, the upper end 52a of the opening/closing operation portion 5b is fixed onto the back of the hanger 6 as shown in FIGS. 11B and 11C. Thus, when the soft medical container 12 is held with one hand to open the mouth 4 as shown in FIG. 12, the hanger 6 is pulled downwardly by the opening/closing operation portion 5b. Consequently, in the soft medical container 12, by inserting fingers into the through paths 7a and 7b, respectively, to separate the soft plastic sheets 2a and 2b forming the mouth 4 from each other, the hanger 6 tilts outwardly with respect to the mouth 4 and keeps that state. Thus, the soft medical container 12 is preferable because a liquid material can be poured into the container portion 21 more readily.

As long as the hanger 6 can be pulled downwardly by the opening/closing operation portion 5b in an effective manner, the location for fixing the upper end 52a of the opening/closing operation portion 5b is not particularly limited. However, as shown in FIG. 11C, W3 as the distance from the proximal end of the hanger 6 to the upper end 52a is preferably 15 mm or more because it becomes more easier for the hanger 6 to tilt outwardly with respect to the mouth 4 when fingers are inserted into the through paths 7a and 7b, respectively, to separate the soft plastic sheets 2a and 2b forming the mouth 4 from each other.

### Embodiment 5

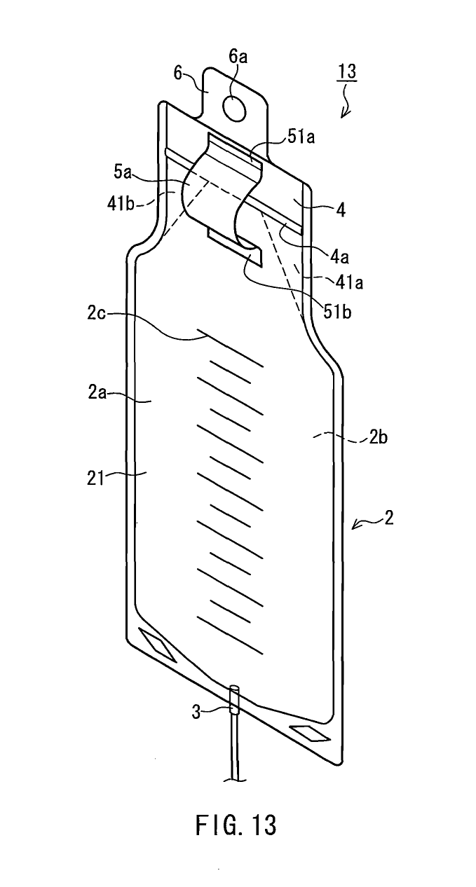

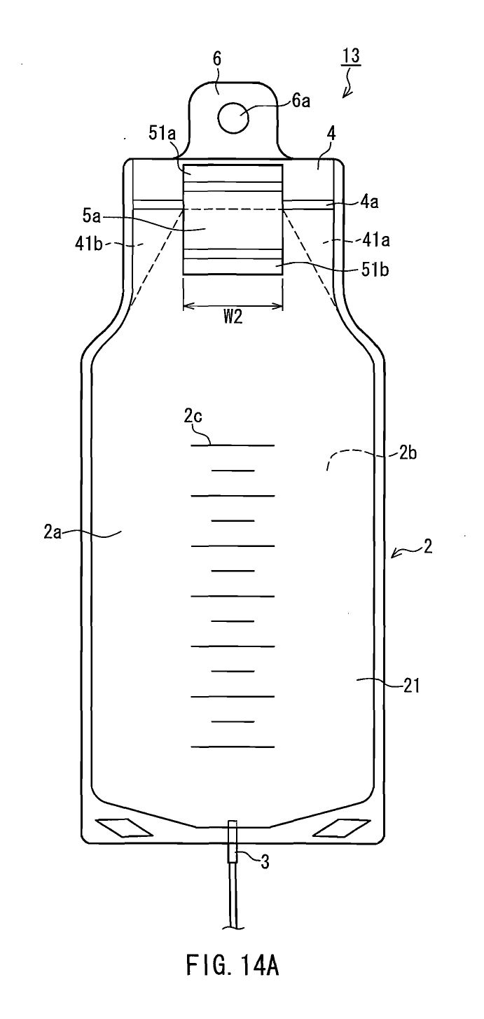

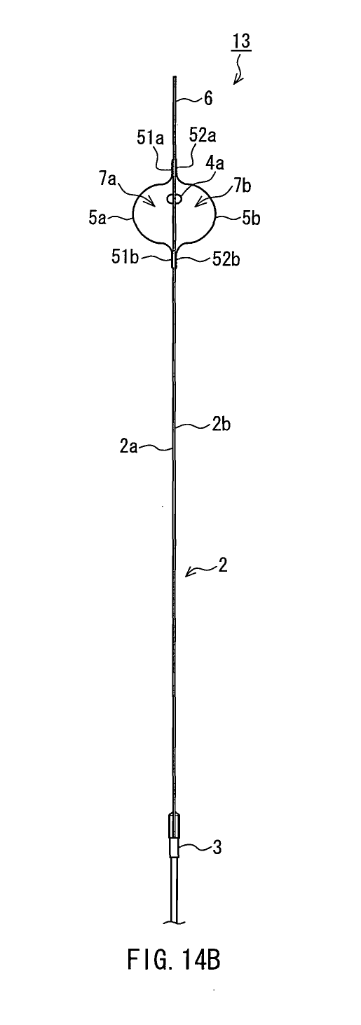

FIG. 13 is a perspective view of an exemplary soft medical container according to Embodiment 5 of the present invention, FIG. 14A is a plan view of the soft medical container shown in FIG. 13, and FIG. 14B is a side view of the soft medical container shown in FIG. 13.

The soft medical container 13 according to the present embodiment has the same configuration as that of the soft medical container according to Embodiment 1 except for the shape of the mouth 4, the shape of the hanging hole 6a, the opening/closing operation portions 5a and 5b having no slit 5c (see FIG. 1), and the width W2 of each of the opening/closing operation portions 5a and 5b in the lateral direction (see FIG. 2A) being smaller than that in the soft medical container 1 shown in FIG. 2A. In FIGS. 13 to 15, the same components as those of the soft medical container according to Embodiment 1 are denoted by the same reference numerals

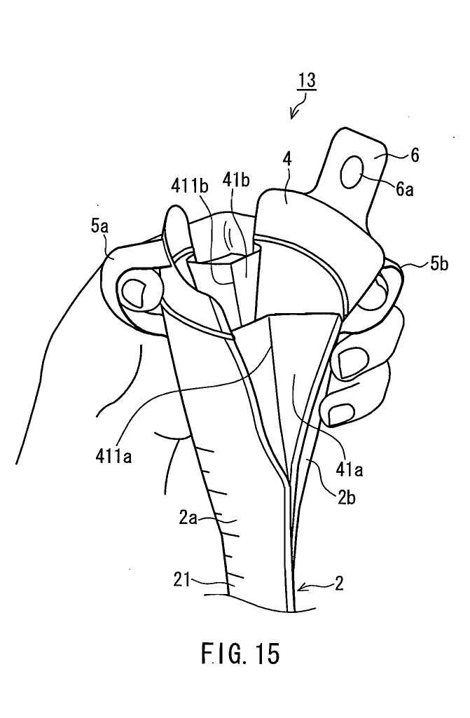

In the soft medical container 13 according to the present embodiment, the mouth 4 includes gussets (side gussets) 41a and 41b on both sides. Thus, when the soft medical container 13 is held with one hand to open the mouth 4 as shown in FIG. 15, the mouth 4 can be spread wide open. Thus, the soft medical container 13 is preferable because a liquid material can be poured into the container portion 21 more readily. When the mouth 4 is not open, each of the gussets 41a and 41b is folded and is sandwiched between the soft plastic sheets 2a and 2b. In the example shown in FIG. 14A, the gussets 41a and 41b are triangular in shape and have a crease 411a and a crease 411b, respectively, (see FIG. 15) in a plan view of the soft medical container 13 when the mouth 4 is not open. However, the gussets 41a and 41b in a folded state do not have to be triangular in planar shape and may be rectangular in planar shape. Further, the gussets 41a and 41b may have one or more creases.

### Embodiment 6

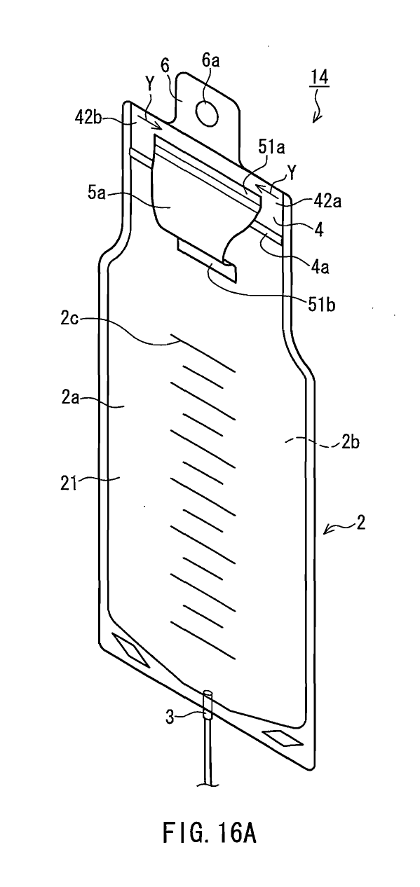

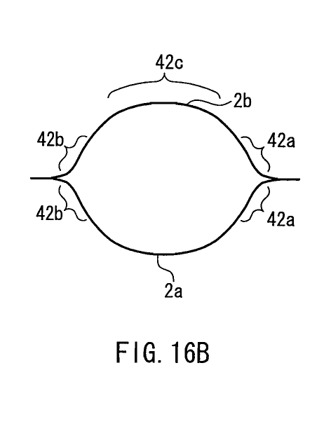

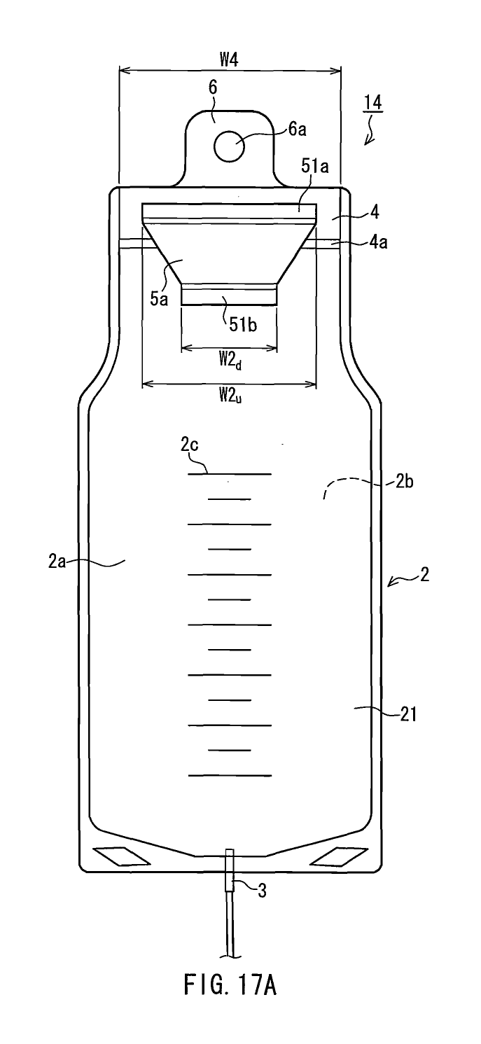

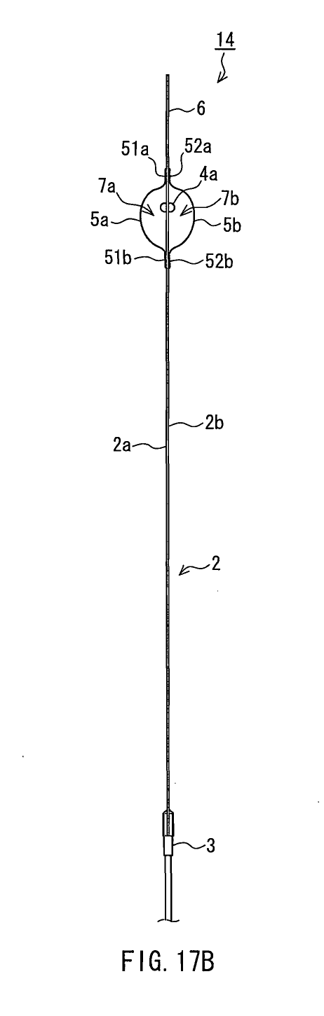

FIG. 16A is a perspective view of an exemplary soft medical container according to Embodiment 6 of the present invention, FIG. 16B is a schematic plan view for explaining the mouth of the soft medical container shown in FIG. 16A in an opened state, FIG. 17A is a plan view of the soft medical container shown in FIG. 16A, and FIG. 17B is a side view of the soft medical container shown in FIG. 16A.

The soft medical container 14 according to the present embodiment has the same configuration as that of the soft medical container 1 according to Embodiment 1 except for the shape of the hanging hole 6a, the shape of the opening/closing operation portions 5a and 5b, and the opening/closing operation portions 5a and 5b having no slit 5c (see FIG. 1). In FIGS. 16A to 17B, the same components as those of the soft medical container according to Embodiment 1 are denoted by the same reference numerals.

In the soft medical container 14 according to the present embodiment, W2_{U} as the width of the upper end 51a of the opening/closing operation portion 5a and the width of the upper end 52a of the opening/closing operation portion 5b in the lateral direction is larger than that in, for example, the soft medical container 1 according to Embodiment 1 and the opening/closing operation portions 5a and 5b become gradually smaller in width toward a lower position. In this case, when the plastic sheets 2a and 2b are pulled through the opening/closing operation portions 5a and 5b to separate the soft plastic sheets 2a and 2b from each other, a strong force acts on portions 42b dose to the left end and portions 42a dose to the right end of the mouth 4 such that each portion is pulled toward a midsection 42c (e.g., in the arrow Y direction). On the other hand, as a result of the portions 42b close to the left end and the portions 42a dose to the right end being pulled in the arrow Y direction, the midsection 42c of the mouth 4 sits at or close to a portion where the soft plastic sheets 2a and 2b are most distant from each other, and the soft plastic sheets 2a and 2b have an arch-like outline with a natural curve in the midsection 42c as shown in FIG. 16B. Therefore, the distance between the two sheets of the soft medical container 14 in the midsection 42 becomes larger than that in a soft medical container whose opening/closing operation portions 5a and 5b have a width constant in the vertical direction and equal to W2_{U} as the width of the upper end 51a of the opening/closing operation portion 5a and the width of the upper end 52a of the opening/closing operation portion 5b of the soft medical container 14 shown in FIG. 16A. Further, when the mouth 4 is in an opened state, its outline is dose to a circle or ellipse. In this way, the soft medical container 14 is preferable because the mouth 4 can be spread wide open and the mouth 4 in an opened state has an outline suitable for pouring a liquid material into the container. When the width W2_{U} is not constant in the vertical direction, the largest width is assumed to be W2_{U}.

Note that only one of the opening/closing operation portions 5a and 5b may have an upper end (upper end 51a or 52a) whose lateral width W2_{U} is larger than that in, for example, the soft medical container 1 according to Embodiment 1 and become smaller gradually in width toward a lower position. This case is also preferable because the mouth 4 still can be spread wide open.

The ratio of the width W2_{U} to the width W4 of the mouth 4 (the width of the mouth 4 in a plan view of the unopened soft medical container exclusive of the width of the heat bonded parts) (W2_{U}/W4) and the ratio of the width W2_{U} to the lateral width W2_{d} of each of the lower end 51b of the opening/closing operation portion 5a and the lower end 52b of the opening/closing operation portion 5b (the length of the side closer to the upper ends 51a, 52a) (W2_{U}/W2_{d}) are preferably 5/10 to 10/10 (=(W2_{U}/W4)) and 10/3 to 10/7 (=(W2_{U}/W2_{d})), respectively, and more preferably 6/10 to 8/10 (=(W2_{U}/W4)) and 10/4 to 10/6 (=(W2_{U}/W2_{d})), respectively, because the mouth 4 can be spread wide open. The width W2_{U} varies depending on the size of the operator's hand but is preferably 5 to 9 cm, and more preferably 6 to 8 cm.

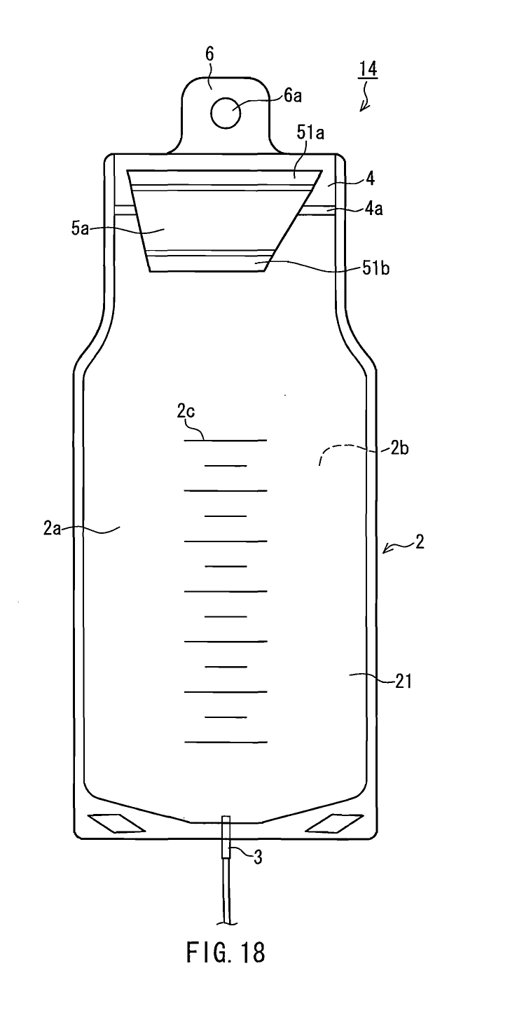

The example explained with reference to FIGS. 16A and 17B is more preferable because the mouth 4 and the opening/closing operation portions 5a and 5b are left-right symmetric with respect to a line extending from the central axis of the outlet port 3 as the axis of symmetry, so that the operability does not change regardless of the dominant hand. However, the soft medical container 14 according to the present embodiment may be configured differently, and each of the opening/closing operation portions 5a and 5b may have an asymmetrical shape as shown in FIG. 18, for example.

### Embodiment 7

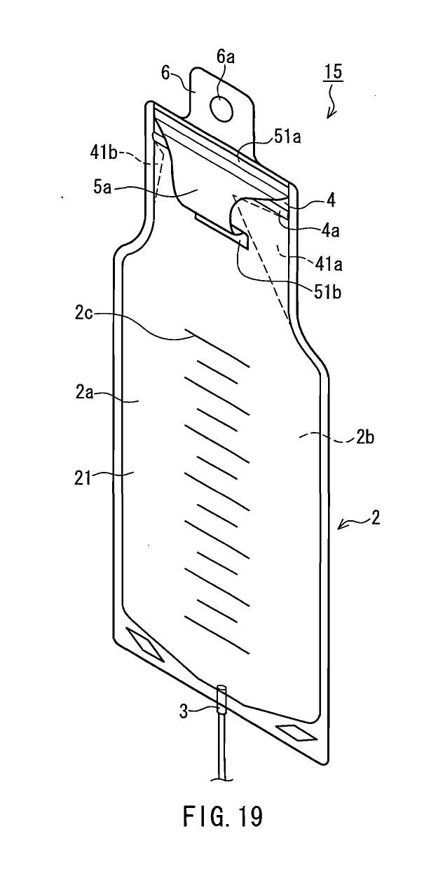

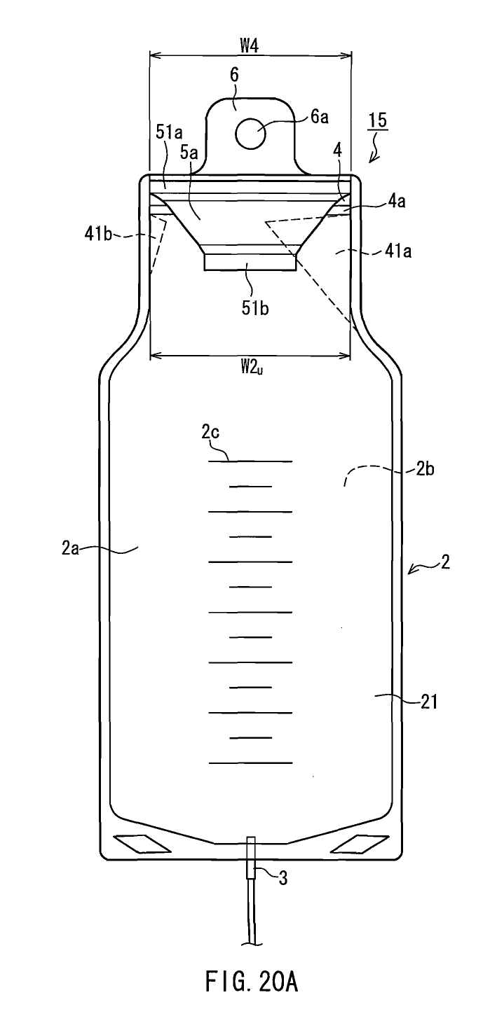

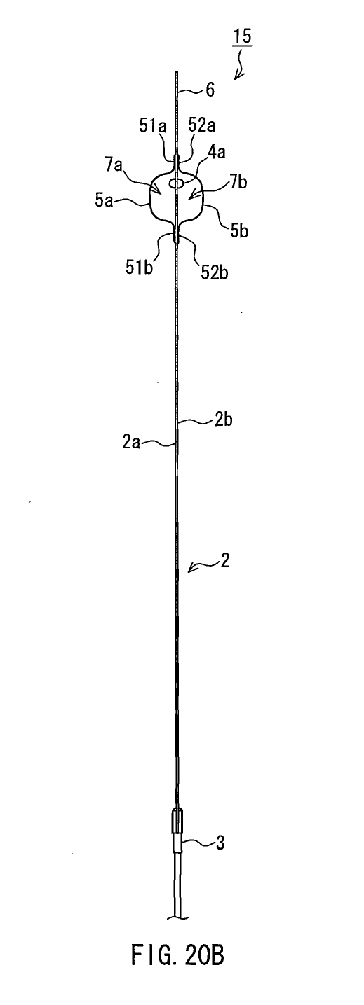

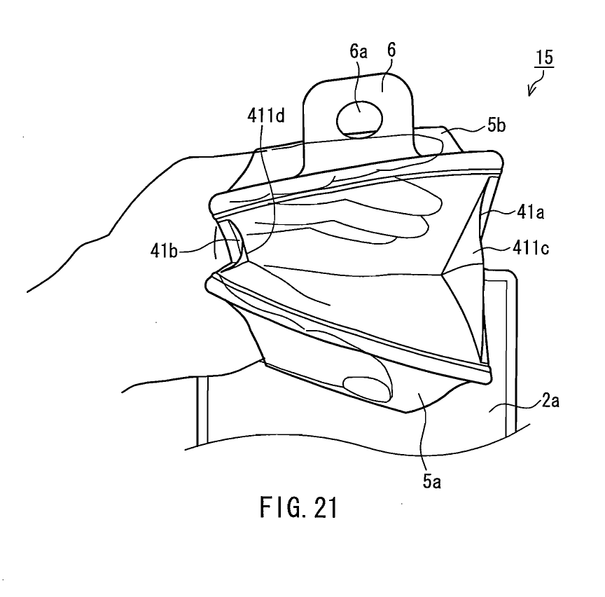

FIG. 19 is a perspective view of an exemplary soft medical container according to Embodiment 7 of the present invention, FIG. 20A is a plan view of the soft medical container shown in FIG. 19, FIG. 20B is a side view of the soft medical container shown in FIG. 19, and FIG. 21 is a diagram showing a state where the soft medical container shown in FIG. 19 is held with one hand to open the mouth.

The soft medical container 15 according to the present embodiment has the same configuration as that of the soft medical container according to Embodiment 5 except for the shape of the mouth 4 and the shape of each of the opening/closing operation portions 5a and 5b. In FIGS. 19 to 21, the same components as those of the soft medical container according to Embodiment 5 are denoted by the same reference numerals.

As in the soft medical container according to Embodiment 5, the mouth 4 of the soft medical container 15 according to the present embodiment includes gussets (side gussets) 41a and 41b on both sides. As shown in FIG. 21, a surface 411d of the gusset 41b facing the inside of the container portion 21 is smaller in area than a surface 411c of the gusset 41a facing the inside of the container portion 21. Thus, even an operator with short fingers can effectively exert on the gusset 41a side of the soft medical container 15 a force that separates the soft plastic sheets 2a and 2b from each other by inserting his fingers into the through paths 7a and 7b, respectively, from the gusset 41b side (the left side of the mouth 4) and separating the plastic sheets 2a and 2b from each other with the gusset 41b being placed close to the operator's palm. Thus, the soft medical container 15 is preferable because it is possible to ensure a large opening and to carry out the pouring of the liquid material readily regardless of the hand size.

When pouring a liquid material into the container portion 21, the pouring can be carried out readily if the spout of a liquid material-filled container is brought to or brought closer to a portion of the mouth where the two soft plastic sheets 2a and 2b are most distant from each other. However, it is difficult to pour the liquid material if the spout is situated close to the hand holding the soft medical container.

As shown in FIG. 21, in the soft medical container 15, the surface 411c is larger in area than the surface 411d. For this reason, the mouth 4 can be opened such that the distance between the soft plastic sheets 2a and 2b is larger on the gusset 41a side, the side farther from the hand holding the soft medical container 15, than on the gusset 41b side, the side closer to the hand holding the soft medical container 15, in the width direction of the mouth 4. Thus, in the soft medical container 15, a liquid material can be poured readily by bringing the spout of a liquid material-filled container closer to the gusset 41a that is farther from the hand holding the soft medical container.

In the soft medical container 15, as in the soft medical container 14 according to Embodiment 6, W2_{U} as the width of the upper end of each of the opening/closing operation portions 5a and 5b in the lateral direction is larger than that in, for example, the soft medical container 1 according to Embodiment 1 and the opening/closing operation portions 5a and 5b become gradually smaller in width toward a lower position. In the soft medical container 15, the width W2_{U} is equal to or substantially equal to the width W4 of the unbonded part of the mouth 4. This is preferable because when the width W2_{U} is large even a person with short fingers can open the mouth 4 more readily such that the distance between the soft plastic sheets 2a and 2b becomes larger on the 41a side of the soft medical container 15 (the side farther from the palm)

In the state shown in FIG. 21, the operator's dominant hand is his right hand and the hand holding the soft medical container 15 is his left hand. However, if both the soft plastic sheets 2a and 2b are marked with the scale 2c, the operator can pour a liquid material into the soft medical container 15 stably while reading the scale during the pouring of the liquid material, regardless of his dominant hand.

### Embodiment 8

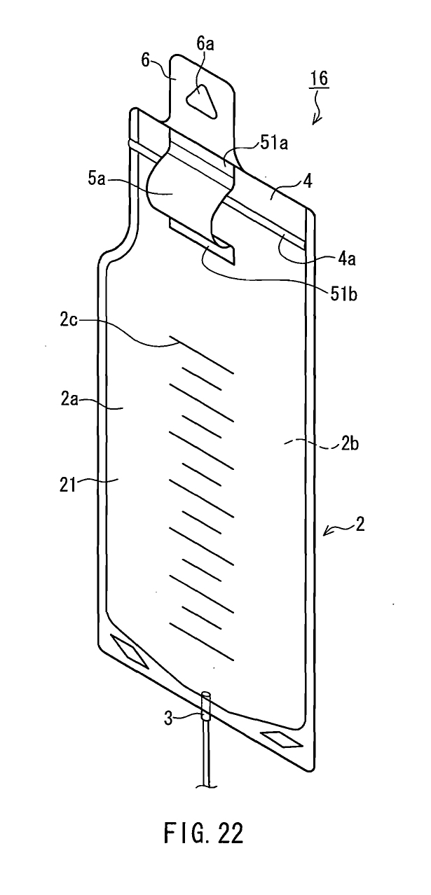

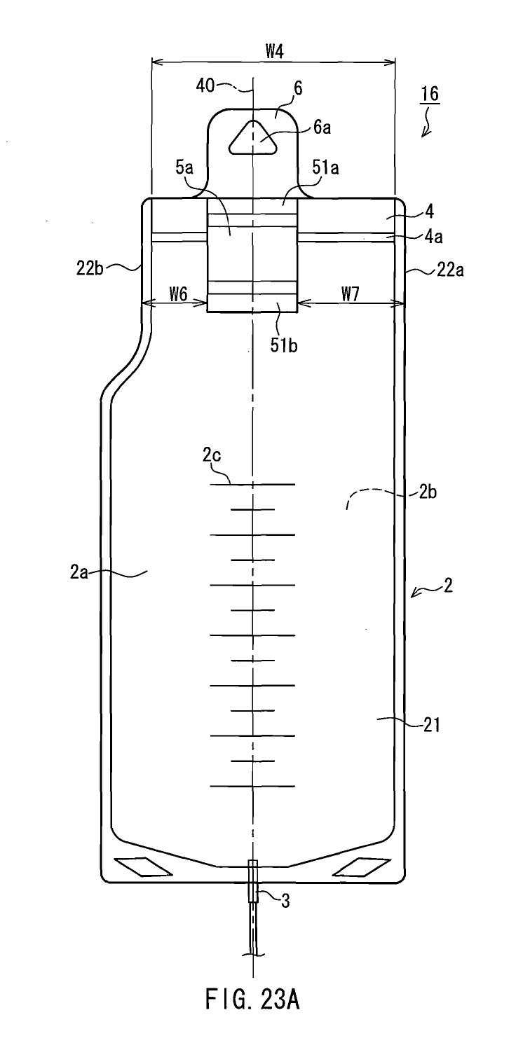

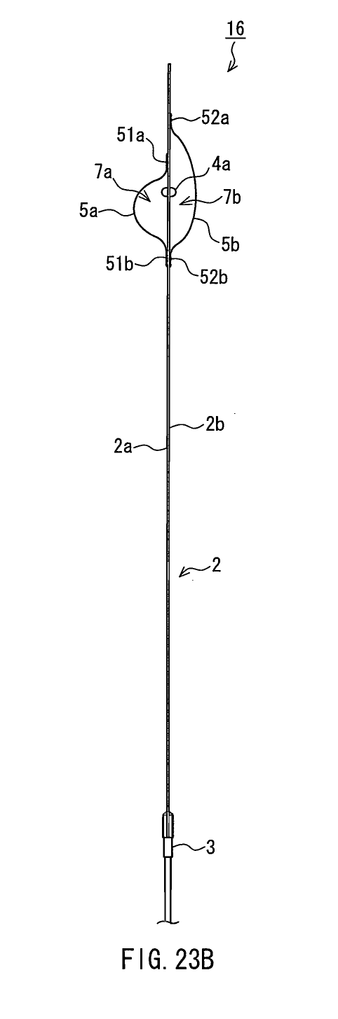

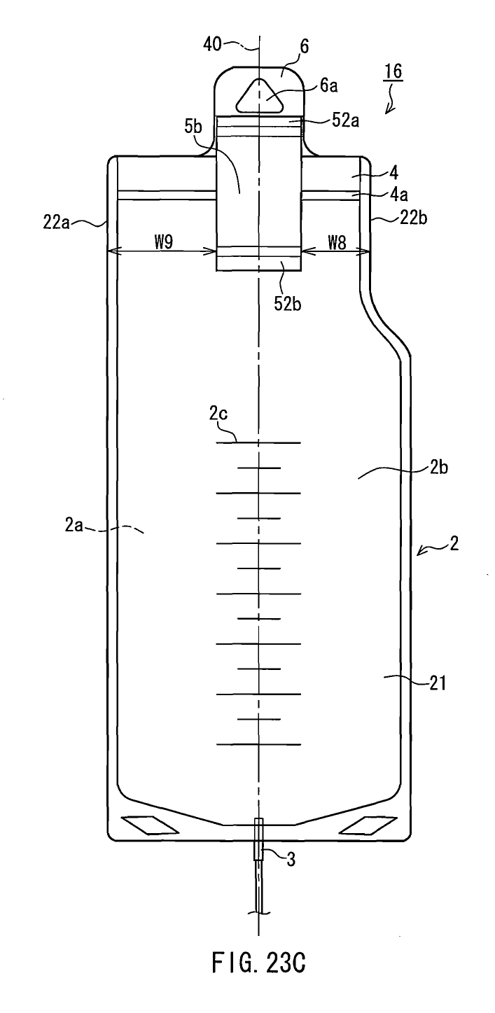

FIG. 22 is a perspective view of an exemplary soft medical container according to Embodiment 8 of the present invention, FIG. 23A is a plan view of the soft medical container shown in FIG. 22, FIG. 23B is a side view of the soft medical container shown in FIG. 22, and FIG. 23C is a rear view of the soft medical container shown in FIG. 22.

The soft medical container 16 according to the present embodiment has the same configuration as that of the soft medical container according to Embodiment 4 except for the shape of the upper part of the flexible bag member 2 and the shape of the mouth 4, the shape of the hanging hole 6 being not circular but triangular, and the closing/opening operation portion 5a having no hole. In FIGS. 22 to 23C, the same components those of the soft medical container according to Embodiment 4 are denoted by the same reference numerals.

As shown in FIGS. 23A and 23C, in the soft medical container 16 according to the present embodiment, W6 as the length from the opening/closing operation portion 5a to one side end 22b of the flexible bag member 2 is smaller than W7 as the length from the opening/closing operation portion 5a to the other side end 22a of the flexible bag member 2 and W8 as the length from the opening/closing operation portion 5b to the side end 22b of the flexible bag member 2 is smaller than W9 as the length from the opening/closing operation portion 5b to the other side end 22a of the flexible bag member 2 in a part of the flexible bag member 2 lying at the same position as that of the pair of opening/closing operation portions 5a and 5b in the vertical direction. Thus, even a person with short fingers can open the mouth 4 more readily such that the soft plastic sheets 2a and 2b become distant from each other by inserting his fingers into the through paths 7a and 7b, respectively, from the side end of the flexible bag member 2 closer to the opening/closing operation portions 5a and 5b (from the left side of the mouth 4 in FIG. 23A) and pressing the fingers against the inner surface of the opening/closing operation portions 5a and 5b to separate the soft plastic sheets 2a and 2b from each other.

When the shape of the flexible bag member 2 is left-right asymmetric as above, the hanging hole 6a is preferably on an extension line 40 from the central axis of the outlet port 3. In this else, when the soft medical container 16 is hung on a stand or the like, the amount of liquid material held in the container portion 21 can be checked relatively precisely through the scale marked on the front side of the container portion 21.

Further, the extension line 40 is also a center line that divides each of the opening/closing operation portions 5a and 5b into two equal parts in the width direction. Thus, a liquid material can be poured into the soft medical container 16 in a highly stable manner while supporting the soft medical container 16 with a hand.

Note that there is no need for the extension line 40 to coincide with the center line that divides each of the opening/closing operation portions 5a and 5b into two equal parts.

### Embodiment 9

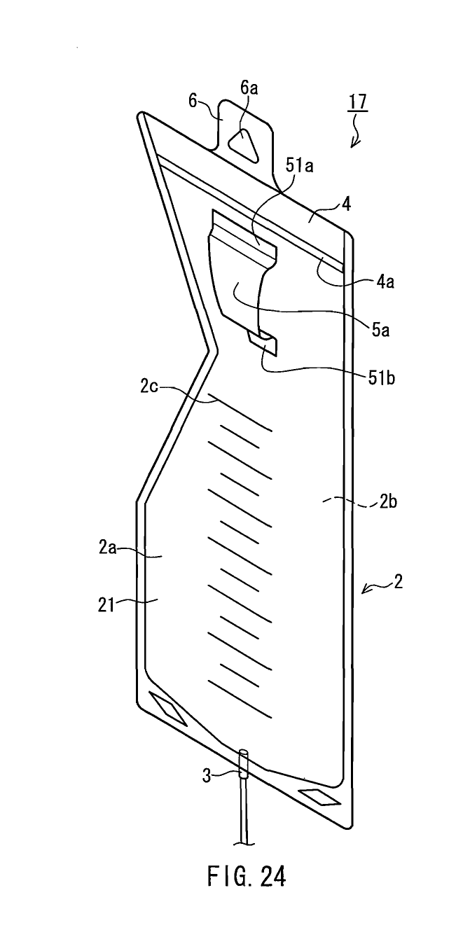

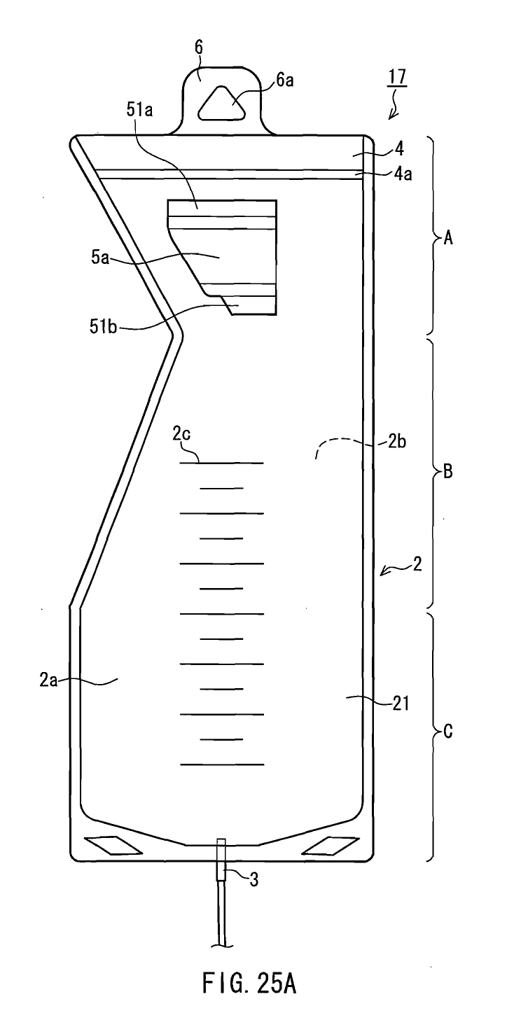

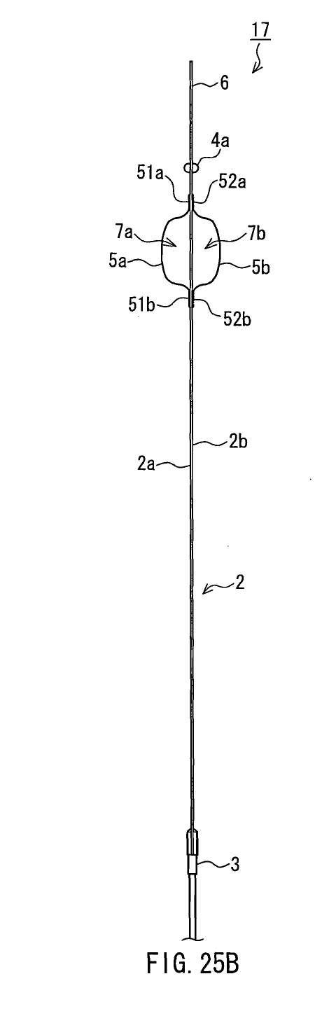

FIG. 24 is a perspective view of an exemplary soft medical container according to Embodiment 9 of the present invention, FIG. 25A is a plan view of the soft medical container shown in FIG. 24, and FIG. 25B is a side view of the soft medical container shown in FIG. 24.

The soft medical container 17 according to the present embodiment has the same configuration as that of the soft medical container according to Embodiment 8 except for the shape of the upper part of the flexible bag member 2, the shape of the mouth 4, the shape of the opening/closing operation portions 5a and 5b and the locations where the opening/closing operation portions 5a and 5b are fixed. In FIGS. 24 to 25, the same components as those of the soft medical container according to Embodiment 8 are denoted by the same reference numerals.

The soft medical container 17 is composed of a part A where the flexible bag member 2 becomes gradually smaller in width toward a lower position from the upper end of the flexible bag member 2, a part B situated on the lower side with respect to the part A and having a width that becomes gradually larger from a certain point on the lower side with respect to the opening/closing operation portions 5a and 5b until it becomes substantially equal to the width of the upper end of the flexible bag member 2, and a part C situated on the lower side with respect to the part B and having a width that is constant in the vertical direction and equal to the width of the upper end of the flexible bag member 2.

Since the upper end of the flexible bag member 2 of the soft medical container 17 is larger in width than that of the soft medical container 16 according to Embodiment 8, a liquid material readily can be poured into the container portion 21. Further, in the soft medical container 17, the opening/closing operation portions 5a and 5b are fixed to a portion of the part A where the width of the flexible bag member 2 is somewhat reduced so that a person with small hands and/or short fingers can readily open the mouth 4. Specifically, not only the lower end 51b of the opening/closing operation portion 5a and the lower end 52b of the opening/closing operation portion 5b but also the upper ends 51a and 52a are fixed respectively to the soft plastic sheets 2a and 2b on the lower side with respect to the engagement portion such as the zip 4a.

In the soft medical container according to the present embodiment, the positional relationship between the zip 4a and the opening/closing operation portions 5a and 5b is not limited to the example shown in FIG. 24 to FIG. 25B as long as the mouth 4 can be opened readily.

Although the soft medical container of the present invention has been explained with reference to the soft medical containers according to Embodiments 1 to 9 as examples, the hanging hole 6a of the soft medical container according to each embodiment does not have to be shaped as shown in each drawing.

### INDUSTRIAL APPLICABILITY

The present invention can provide a soft medical container that can be used suitably not only in transintestine nutrition therapy but also in intravenous nutrition therapy and a nutrient supply system using the soft medical container.

### DESCRIPTION OF REFERENCE NUMERALS

1, 10 to 17 soft medical container

2 flexible bag member

2a, 2b soft plastic sheet

2c scale

3 outlet port

4 mouth

41a, 41b gusset

411d surface of one gusset facing inside of container portion

411c surface of other gusset facing inside of container portion

5a, 5b opening/closing operation portion

5c slit

5d hole

51a, 52a upper end of opening/closing operation portion

51b, 52b lower end of opening/closing operation portion

6 hanger

6a hanging hole

7a, 7b through path

8 line temporary-holding hole

21 container portion

22a other side end of flexible bag member

22b one side end of flexible bag member

50 transintestine nutrition supply system

1. A soft medical container comprising:
a flexible bag member formed by bonding at least two soft plastic sheets together, wherein the flexible bag member comprises a reclosable mouth and a container portion for holding a liquid material, and at least one of principal surfaces of the flexible bag member is marked with a scale for indicating the amount of the liquid material;
an outlet port fixed to the flexible bag member; and
a pair of opening/closing operation portions, wherein the opening/closing operation portions are fixed to the principal surfaces of the flexible bag member, respectively, and each form, together with the soft plastic sheet to which each opening/closing operation portion is fixed, a through path into which a finger can be inserted from the left side or the right side of the flexible bag member.

2. The soft medical container according to claim 1, wherein the opening/closing operation portions each form, together with the soft plastic sheet to which each opening/closing operation portion is fixed, the through path into which a finger can be inserted from the left side or the right side of the mouth.

3. The soft medical container according to claim 1, wherein at least one of the opening/closing operation portions has a slit or hole whose longitudinal direction is in an up-down direction.

4. The soft medical container according to claim 1, wherein the flexible bag member further comprises a hanger situated on the upper side with respect to the mouth and having a hanging hole.

5. The soft medical container according to claim 1, wherein each of the opening/closing operation portions is fixed to the mouth.

6. The soft medical container according to claim 4, wherein an upper end of one of the opening/closing operation portions is fixed to the hanger.

7. The soft medical container according to claim 4, wherein a portion close to a boundary between the hanger and the mouth is made of a material that is easier to bend than the mouth.

8. The soft medical container according to claim 1, wherein the mouth includes gussets on both sides.

9. The soft medical container according to claim 8, wherein a surface of one of the gussets facing the inside of the container portion is smaller in area than a surface of the other gusset facing the inside of the container portion.

10. The soft medical container according to claim 1, wherein at least one of the opening/closing operation portions becomes gradually smaller in width in a lateral direction toward a lower position.

11. The soft medical container according to claim 1, wherein a length from each of the opening/closing operation portions to one side end of the flexible bag member is smaller than a length from each of the opening/closing operation portions to the other side end of flexible bag member in a part of the flexible bag member lying at the same position as the opening/closing operation portions in the vertical direction.

12. A nutrient supply system comprising the soft medical container according to claim 1.
